(19) United States
(12) Patent Application Publication
(10) Pub. No.: US 2017/0167467 A1
(43) Pub. Date: Jun. 15, 2017

(54) MODULAR HYDROKINETIC PADDLING DEVICE AND METHOD

(71) Applicant: Corporacion Andina De Fomento, Caracas (VE)

(72) Inventors: Jose TORAN, Caracas (VE); Alvaro ATILANO, Caracas (VE)

(21) Appl. No.: 15/376,076

(22) Filed: Dec. 12, 2016

Related U.S. Application Data
(60) Provisional application No. 62/266,275, filed on Dec. 11, 2015.

(51) Int. Cl. F03B 17/02; H02K 7/06; H02K 7/18; F03B 17/06; F03B 13/00

(52) U.S. Cl. CPC F03B 17/025; F03B 17/06; F03B 13/00; H02K 7/1853; H02K 7/06

(57) ABSTRACT

A power generation apparatus for generating power from water flows is provided. The apparatus has an elongated module having a mechanical side and a hydraulic side, a generator coupled to the mechanical side. The hydraulic side having a set of paddles partially submerged in a water flow. The elongated module has a pivoting point on its mechanical side so that the hydraulic side follows an arc trajectory. The paddles are configured to change positions based on the angular location of the arc trajectory.

### CROSS REFERENCE TO RELATED APPLICATION

This application claims the benefit of priority of U.S. Provisional Patent Application No. 62/266,275, filed on Dec. 11, 2015, the contents of which is incorporated herein in its entirety by reference.

### FIELD OF THE INVENTION

The present invention relates to devices the covert the linear flow movement of a water current of a river or water channel into rotary movement of an axis in order to then convert this rotary movement into useful energy by means of a generator or drive of any other mechanical or electrical device.

### BACKGROUND OF THE INVENTION

The development and marketing of hydrokinetic renewable energy technologies of low (5 kW) and medium (250 kW) power to provide energy to isolated rural communities near navigable rivers in basins around the world, such as the West Amazon basin and others in Africa and Asia, is a short-term priority due to the high costs of electric energy in isolated communities in these basins. Currently, the governments of these regions are interested in improving the quality of life of communities there, and in reducing the high subsidies that are currently being used to provide energy to these areas. Electric power in these communities is usually provided by small diesel generators that are very costly to operate (diesel must be transported hundreds of kilometers through boats).

Given the geographic, ecologic, and climatic characteristics, as well as the difficult access, areas such as the central part of the West Amazon basin and others have few economically feasible technological alternatives to bring electricity to their communities. The conventional network extension modality commonly used to provide electricity to rural communities and to connect them to the interconnected system is not feasible in these areas not only because of their distances, but also due to the density of the tropical forest, and how inaccessible and dispersed the communities are located.

Another conventional modality currently used to provide electricity to isolated rural communities such as the West Amazon and others, is bringing electricity through network extensions of the isolated systems under concession. The use of this modality is only feasible in communities that are relatively close to departmental or provincial capitals that have isolated systems under concession. In case of one part of the West Amazon electricity has already been provided to the area through the extension of the network from diesel generation isolated systems, located primarily in the provincial and municipal capitals.

The introduction of new technologies to provide electricity to isolated communities in tropical river basins is a way to solve this problem, while at the same time providing support to the technological capacities to strengthen the region's innovative system.

Hydrokinetic energy conversion systems from river currents have been implemented since ancient times. The development of hydrokinetic energy converters for high-flow rivers, but with very low hydraulic or water heads and low speed currents, is in its beginning stages. There are very few technologies available on the market, currently only two: a) Garman axial flow-type turbines; and b) Darrieus cross flow vertical axis turbines. The available Garman turbines have a very low capacity (1 to 2 kW), but greater capacity Darrieus-type turbines can be found in the market (5 to 25 kW). Both types of turbines need a minimum speed of 1.5 m/s to work effectively, and this would limit its use in a great number of the rivers considered in the central area of the West Amazon basin, where the average speed of the flow of water is between 0.9 to 1.3 m/s. Both types of turbines would also be exposed to the risk of being hit by floating material (trees, branches, roots, animals, etc.), which is very common in the Amazon rivers and other tropical river basins.

Therefore, there is the need for the development of technological concepts oriented to work effectively (i.e., generate electricity affordably) in rivers with the conditions and characteristics mentioned above. Ideally, these new technologies should comply with the following parameters: a) the concepts should be modular, and should include the full hydrokinetic energy conversion systems or processes; b) the main source of energy is hydrokinetic, considering speeds of river flows ranging between 0.9 to 1.5 m/s, although these concepts should work at any typical river current speeds; c) the concepts should be designed for capacities starting from 500 W of power and up; d) the concepts should consider the risks of being impacted with floating material (trees, branches, roots, animals, etc.), which are very common in navigable rivers, especially in basins such as the Amazon Basin and others.

### SUMMARY OF THE INVENTION

The present invention relates to a modular paddling device driven by fluid currents to generate upstream and downstream movement with an arc trajectory (a circular or semicircular path) of elements with the objective of generate mechanical and/or electrical power. In particular, the present invention is directed towards a physical embodiment composed by at least two elongated modules each of them comprising a hydraulic and a mechanic side wherein, on the hydraulic side, one or a series of moveable elements called paddles are disposed. Each of those paddles are at least partially submerged in the river water at one end. On the mechanic side of the elongated module a power take off system is envisaged. The operating mode of the device is that when a first of the elongated module has at least one of its paddles at least partially submerged on the current in a first position, the paddles are configured to have a maximum effective area (e.g., when the position of the paddles is perpendicular to the direction of the water current flow) in order to maximize the effect of the current drag on the paddle a second elongated module may be arranged with at least one of its paddles in a position with a lower effective area on the paddles (e.g., when the position of the paddles is parallel to the direction of the current flow) as to have minimum exposure to the current drag. Also, if the elongated modules are coupled so as to always move in opposite directions, the first module moves with the direction of the flow (downstream) by means of the current drag and moves the second module upstream thereby guaranteeing a continuous operation. The effect of the current drag on the paddles can be changed by modifying the fluid in which the paddles move (e.g., by having the paddles go underwater during a first cycle and over the water in a second cycle), by changing the effective area of the paddles in contact with the water flows (e.g., by rotating or modifying the shape of the paddles such as, opening/closing windows, etc.)

The mechanical side of the elongated modules is preferably attached to a pivot axis a certain distance from the end of the modules. At the very end after the pivot axis each elongated module has a semicircular toothed mechanism in contact with a large pinion or toothed wheel. The movement upstream and downstream occurs when the set of submerged paddles at the river end of each elongated module change position at the same time, the one being perpendicular to the direction of the flow becoming parallel the de direction of the flow, and the one parallel to the direction of the flow becoming perpendicular to the direction of the flow. The change of position of both set of paddles makes the movement of the elongated modules to also change direction. This back and forth movement of the elongated modules is transmitted through a semicircular toothed mechanism to a large pinion or toothed wheel, converting the back and forth semicircular movement of the paddles at the river end of the elongated modules in a back and forth rotating movement. This back and forth rotating movement is then transmitted to a shaft into a gearbox, element or equivalent which purpose is to convert this back and forth rotating movement to a rotating movement in a single direction and transmitted to a single rotating direction axis. This last single rotating direction axis or shaft then transmits this power to a generator or drive any other mechanical or electrical device.

It is the main objective of the present invention to use the hydrokinetic energy of a water current source in order to transform it into mechanical or electrical power.

It is another objective of the present invention to allow easy placement of the device on any spot of a water channel, mainly rivers, depending on the characteristics of such channel, especially due to seasonal changes in flow, water level, sediments or any other reason associated to improve device performance, safety, or convenience, without requiring any major civil foundations or construction. It is also an objective of this invention to operate in a reliable way in remote areas with no human attendance during operation and minimal maintenance intervention.

It is another objective of the present invention to provide a resistant structure and mechanisms to survive for collisions with elements being dragged by the water current.

It is another objective of the present invention to be easily transported long distances by any means, especially when being towed or shipped by any small or medium size river crafts.

It is another objective of the present invention to provide a device that can be easily adjusted to operate at a fixed spot in the channel or river with variations of depth level due to sediments and seasonal tides.

It is another objective of this invention to provide different arrays of modules that can be combined in different arrangements in order to achieve objectives like output power increment, output power uniformity, maximize benefit of water source conditions and adaptations to changes on the water source channel.

It is another objective of the present invention to easily increase or reduce modules of power generation according to the energy demand or user requirement. It is also an objective to scale the size of the elements depending on the flow or demand conditions.

It is another objective of the present invention to provide an easy to maintain device considering it may be operating in remote areas far from technical service providers or spare parts suppliers.

All the mechanical transmission elements are located outside of the water in order to minimize failures due to collision or jams with debris or elements being dragged by the water current, as well as to minimize maintenance because of corrosion and lack of lubrication.

### BRIEF DESCRIPTION OF THE DRAWINGS

FIG. 1 is a general top view of the first embodiment of two elongated modules with paddles at one end (the river side end) in one position and with semicircle rack in contact with a power take off system during operation.

FIG. 2 is a general side view of the first embodiment of two elongated modules with paddles at one end (the river side end) in one position and with semicircle rack in contact with a power take off system during operation.

FIG. 3 is another general top view of the first embodiment of two elongated modules with paddles at one end (the river side end) in another position and with semicircle rack in contact with a power take off system during operation.

FIG. 4 is another general side view of the first embodiment of two elongated modules with paddles at one end (the river side end) in another position and with semicircle rack in contact with a power take off system during operation.

FIG. 5 is yet another general top view of the first embodiment of two elongated modules with paddles at one end (the river side end) in another position and with semicircle rack in contact with a power take off system during operation.

FIG. 6 is yet another general top view of the first embodiment of two elongated modules this time with a series of paddles at the river end of each module.

### DETAILED DESCRIPTION OF THE INVENTION

The following figures are not to scale. The actual dimension and/or shape of each of the device components may vary. Only important details of the device are shown, however one of ordinary skill in the art can appreciate how the overall device may be constructed, without undue experimentation. As the main function of the device relates to transforming the drag force exerted by a water flow on submerged paddles mounted in elongated modules, it is theoretically well known that such dragging force is proportional to geometrical elements of the paddle (dragging coefficient and projected area perpendicular to the flow) and properties of the flow (speed and density), so certain small geometric or shape modification of the paddles with respect the shapes shown in these figures are considered in order to increase the dragging coefficient. Regarding the paddle size and number in each elongated module, as it is proportional to the drag force, it will depend on the desired level of power generation and the conditions of the water source where it will be placed.

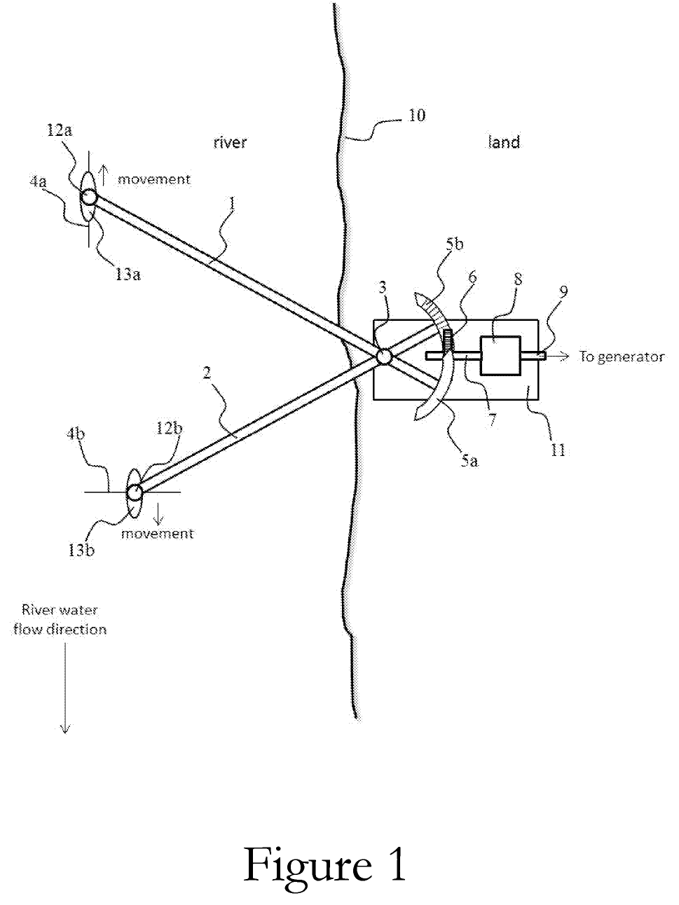

FIG. 1 is a general top view of the first embodiment of two elongated modules with paddles at one end (the river side end) in one position and with semicircle rack (semicircular toothed wheel) in contact with a power take off system during operation. The apparatus is composed by a least two elongated modules 1 and 2, attached to a pivoting axis 3. At the river or water end of each of the elongated modules there is a set of paddles. The set of paddles 4a of elongated module 1 is in a position parallel to the direction of the river or water flow, therefore having the paddles 4a little exposure to the drag force of the current of the water or fluid, the elongated module 1 is located at a first angular position. In this position of paddles 4a, the water end of the elongated module 1 is moving upstream. The set of paddles 4b of elongated module 2 is in a position perpendicular to the direction of the river or water flow, therefore having the paddles 4b totally exposure to the drag force of the current of the water or fluid. In this position of paddles 4b, the water end of the elongated module 2 is moving downstream. At the mechanical side, at the end of elongated module 1 there is a semicircular rack 5a that is in contact with the upper side of large pinion or dented wheel 6, as to transmit the upstream movement of the set of paddles 4a to shaft 7, converting the elongated module 1 movement to a rotary movement. Looking at large pinion or dented wheel 6 from left to right in FIG. 1, pinion 6 is moving clockwise at this moment. At the land end of elongated module 2 there is a semicircular rack 5b that is in contact with the lower side of large pinion or dented wheel 6, as to transmit the downstream movement of the set of paddles 4b to shaft 7, converting the elongated module 2 movement to a rotary movement. Looking at large pinion or toothed wheel 6 from left to right in FIG. 1, pinion 6 is moving clockwise at this moment. The movements of both elongated modules 1 and 2 shift or change direction when the position of paddles 4a and 4b change from parallel and perpendicular and from perpendicular to parallel respectively in relation to the direction of the flow current, the apparatus according to the present invention can be configured to change the position of the paddles depending on the angular position of the elongated body. This repeats the cycle again but now in the opposite direction, ending with pinion 6 moving counterclockwise if seen from left to right in FIG. 1. Then shaft 7 transmit the back and forth rotary movement derived from the cycles described above to a gearbox 8 which purpose is to convert this back and forth rotary movement to a rotary movement in a single direction. This rotary movement in a single direction is then transmitted to shaft 9 that transmits this power to a generator or drive any other mechanical or electrical device. As can be seen in FIG. 1, the power take off system is in land (left of coast line 10) mounted on a chassis 11. The paddles at the river end of elongated modules 1 and 2 change positions (parallel or perpendicular the direction of the flow) through component 12a and 12b respectively. In order to give stability to the set of paddles at the river end of each elongated module, there are float 13a and 13b just above each set of paddles.

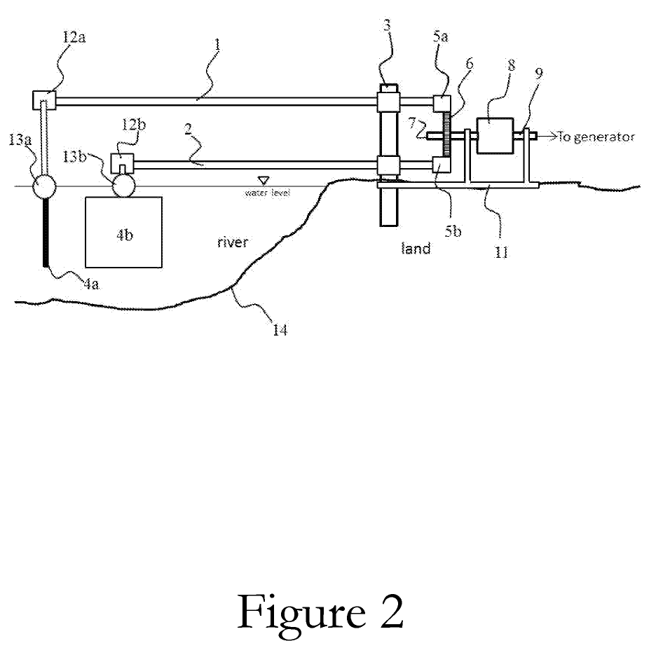

FIG. 2 is a general side view of the first embodiment of two elongated modules with paddles at one end (the river side end) in one position and with semicircle rack in contact with a power take off system during operation. As it can be seen from the figure, the paddle 4a of elongated module 1 are in a position parallel to the direction of the flow, making the river end of the elongated module 1 move inward in FIG. 2. Also as it can be seen from the figure, the paddle 4b of elongated module 2 are in a position perpendicular to the direction of the flow, exposing it to the full drag force of the water and making the river end of the elongated module 2 move outward in FIG. 2. In this figure, the bottom of the river 14 can be seen and also the different in size of elongated modules 1 and 2 can be appreciated. This different in size of the elongated modules 1 and 2 is necessary as to avoid collision of the paddles when they pass site by site during each cycle.

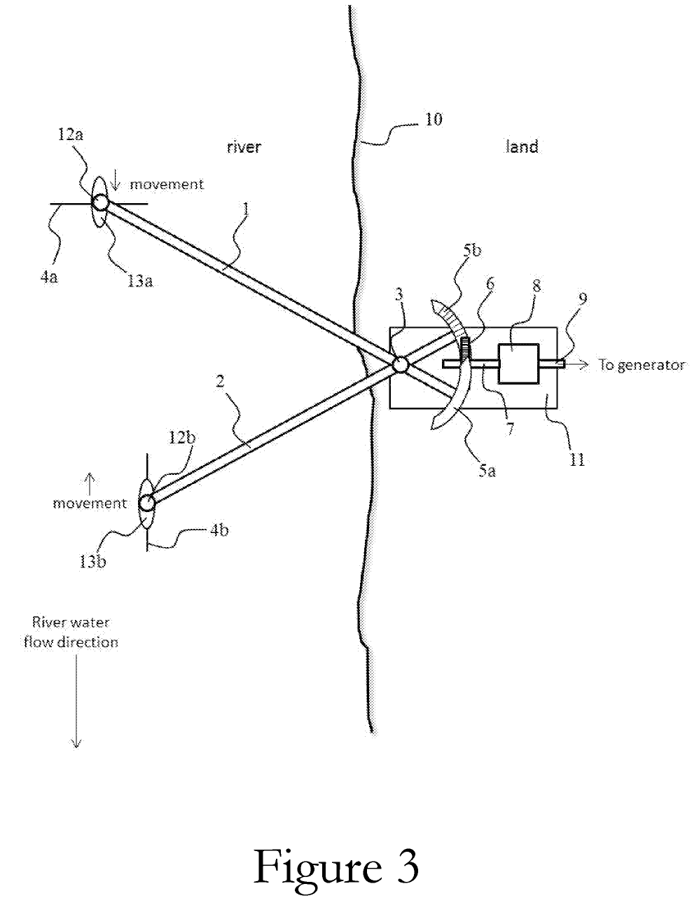

FIG. 3 is another general top view of the first embodiment of two elongated modules with paddles at one end (the river side end) in another position and with semicircle rack in contact with a power take off system during operation. The set of paddles 4a of elongated module 1 is in a position perpendicular to the direction of the river or water flow, therefore having the paddles 4a maximum exposure to the drag force of the current of the water or fluid, i.e., a maximum effective area. In this position of paddles 4a, the water end of the elongated module 1 is moving downstream. The set of paddles 4b of elongated module 2 is in a position parallel to the direction of the river or water flow, therefore having the paddles 4b minimum exposure to the drag force of the current of the water or fluid, i.e., having a minimum effective area. In this position of paddles 4b, the water end of the elongated module 2 is moving upstream. At the land end of elongated module 1 there is a semicircular rack 5a that is in contact with the upper side of large pinion or dented wheel 6, as to transmit the upstream movement of the set of paddles 4a to shaft 7, converting the elongated module 1 movement to a rotary movement. Looking at large pinion or dented wheel 6 from left to right in FIG. 3, pinion 6 is moving counterclockwise at this moment.

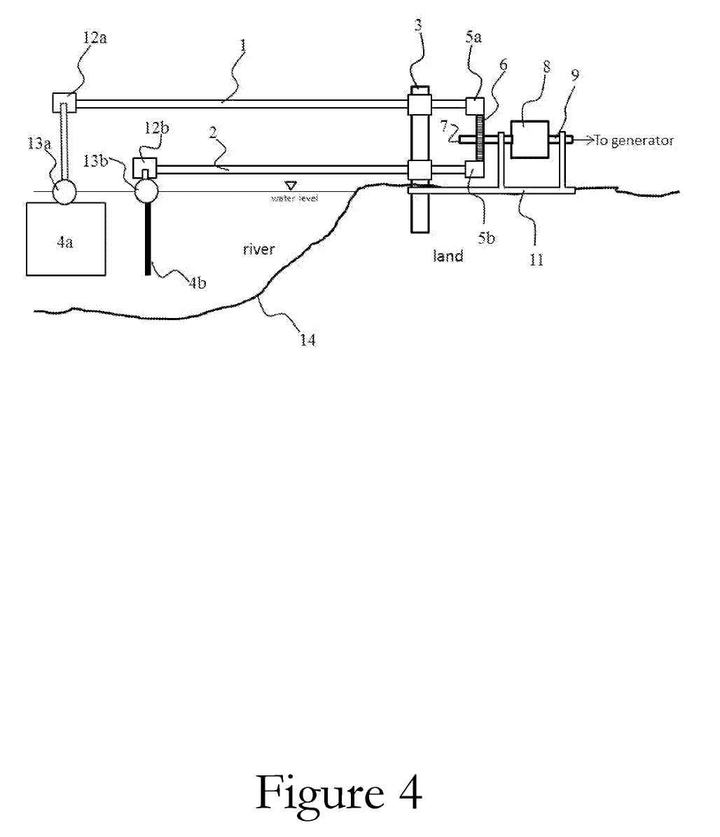

FIG. 4 is another general side view of the first embodiment of two elongated modules with paddles at one end (the river side end) in another position and with semicircle rack in contact with a power take off system during operation. As it can be seen from the figure, the paddle 4a of elongated module 1 are in a position perpendicular to the direction of the flow, exposing it to maximum drag force of the current and making the river end of the elongated module 1 move outward in FIG. 4. Also as it can be seen from the figure, the paddle 4b of elongated module 2 are in a position parallel to the direction of the flow, exposing it to minimum drag force of the water and making the river end of the elongated module 2 move inward in FIG. 4.

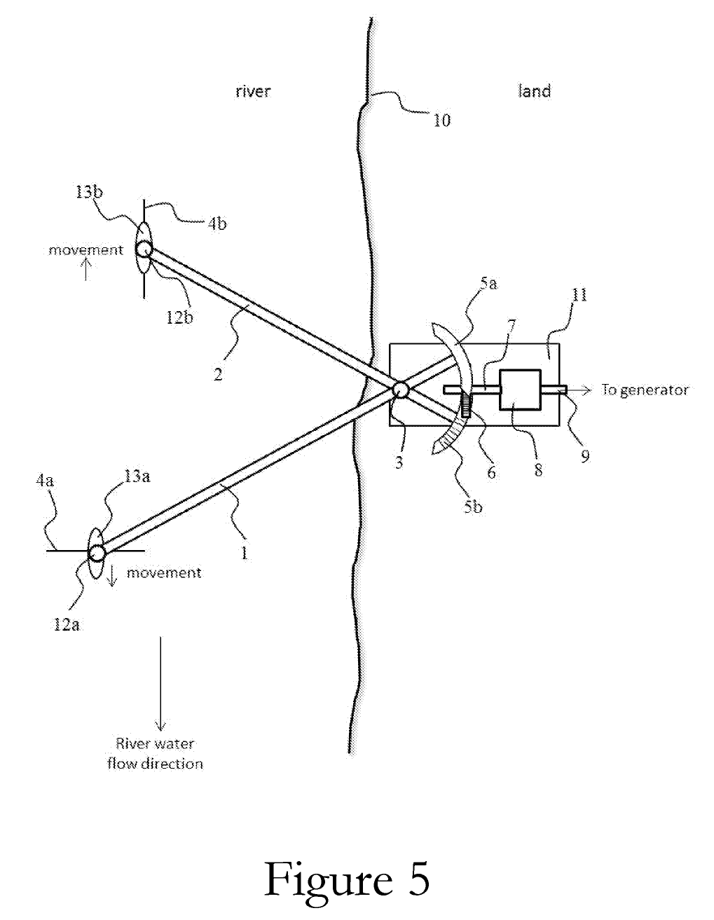

FIG. 5 is yet another general top view of the first embodiment of two elongated modules with paddles at one end (the river side end) in another position and with semicircle rack in contact with a power take off system during operation. The set of paddles 4a of elongated module 1, in a position perpendicular to the direction of the river or water flow, has reached the end of its cycle and is at the farthest down position in FIG. 5.

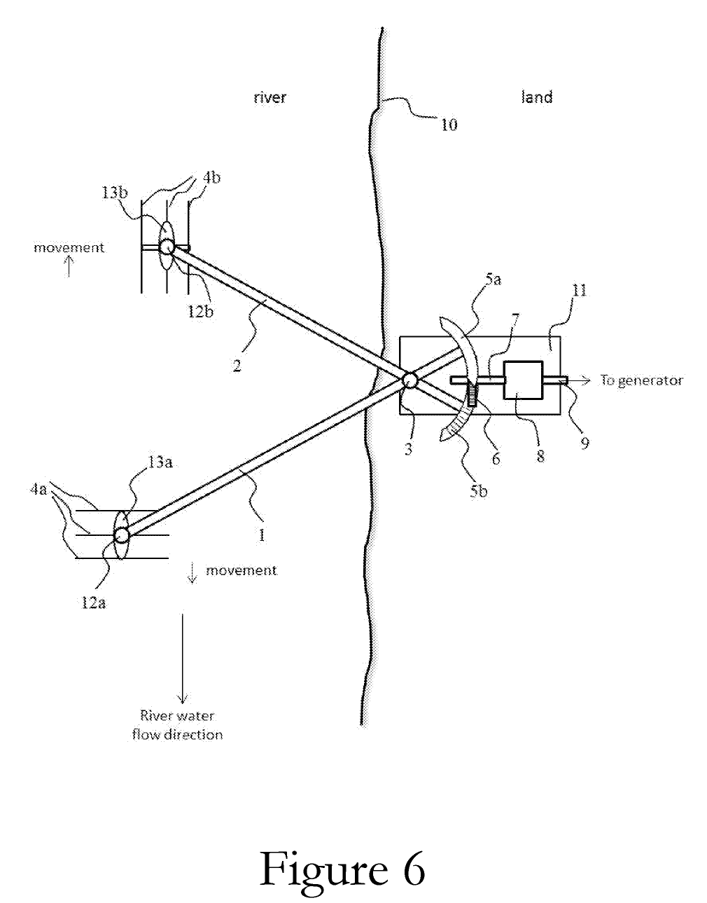

FIG. 6 is yet another general top view of the first embodiment of two elongated modules this time with a series of paddles at the river end of each module. The set of paddles 4a and 4b of elongated modules 1 and 2 are composed of several paddles in order to increased power take off of the system or device.

We claim:

1. A power generation apparatus for generating power from water flows, the power generation apparatus comprising:
an elongated module comprising a mechanical side and a hydraulic side; and
a generator coupled to the mechanical side of the elongated module;
wherein the hydraulic side comprises a set of paddles along such elongated module being such paddles disposed at least partially submerged in a water flow and wherein such paddles further comprise means from changing from a first position having a first effective area and a second position having a second effective area which is lower that the first effective area;
wherein the elongated module is attached, on its mechanical side, to a pivoting point so that the hydraulic side follows an arc trajectory from a first angular position to a second angular position;
being the paddles configured to to change to its first position when the elongated module is at the first angular location and to change to the second position when the elongated module is at the second angular location.

2. The power generation apparatus according to claim 1 wherein the first angular location is a location upstream the second angular location with respect to the water flow.

3. The power generation apparatus according to claim 1 wherein the first position of the paddles is a position wherein the paddles are substantially perpendicular to the water flow.

4. The power generation apparatus according to claim 1 wherein the second position of the paddles is a position wherein the paddles are substantially parallel to the water flow.

5. The power generation apparatus according to claim 1 wherein the elongated module is connected to the generator by means of a toothed mechanism connected to a toothed wheel on the generator.

6. The power generation apparatus according to claim 5 wherein the toothed mechanism has an arc shape.

7. The power generation apparatus according to claim 1 wherein the apparatus comprises at least two elongated modules.

8. The power generation apparatus according to claim 7 wherein the elongated modules are located at different heights.

9. The power generation apparatus according to claim 7 wherein the modules are located at different angular positions.

10. The power generation apparatus according to claim 9 wherein at least two modules are coupled to move at opposite directions.

11. The power generation apparatus according to claim 10 wherein the modules are connected to opposite sides of a toothed wheel.
